(19) United States
(12) Patent Application Publication
(10) Pub. No.: US 2008/0012790 A1
(43) Pub. Date: Jan. 17, 2008

(54) Rear Projection-Type Multi-Picture Display Device and Collective Screen, Optical Fiber for Collective Screen, and Flat Optical Fiber That are Used for the Display Device

(76) Inventor: Keisuke Matsuyama, Machida (JP)

Correspondence Address: QUINN EMANUEL;KODA & ANDROLIA, 865 S. FIGUEROA STREET, 10TH FLOOR, LOS ANGELES, CA, 90017, US

(21) Appl. No.: 10/586,113

(22) PCT Filed: Jan. 13, 2005
(86) PCT No.: PCT/JP05/00310

§ 371 Date: Aug. 17, 2007

(30) Foreign Application Priority Data
Jan. 15, 2004 (JP) 2004-008274

(51) Int. Cl. G09G 5/00

(52) U.S. Cl. 345/1.3

(57) ABSTRACT

A rear projection multi-screen display device for preventing boundary lines from appearing on a larger screen when images are projected from multiple projectors onto screens to thereby form the large screen. The rear projection multi-screen display device 10 includes projectors 12 and a collective screen 16. The collective screen 16 includes short unit screens 18 and long unit screens 20, which are different in length. The projectors 12 are the same in number as the short unit screens 18 and long unit screens 20, and disposed to project an optical image onto their rear end surfaces or optical image input faces. Each of the unit screens 18 and 20 is provided with multiple optical fibers 28 which have the same length in the range of 5 mm to 100 cm and are integrally joined together so that their front ends and rear ends are aligned substantially in radial contact with each other. The short unit screens 18 and the long unit screens 20 are disposed in a staggered arrangement when viewed from their front, and their optical image output faces 18A and 20A are disposed adjacent to each other across the collective optical image output face 16A.

### TECHNICAL FIELD

The present invention relates to a rear projection multi-screen display device which employs a combination of multiple screens to form a larger screen, to a collective screen, and to an optical fiber and a flat optical fiber for a collective screen used for the same.

### BACKGROUND ART

Recently, large flat displays such as plasma displays have been developed.

These plasma displays or liquid crystal displays have a size limit because the yields of the devices are reduced in their manufacturing processes as their screen size increases. Accordingly, for example, to provide a 100-inch size screen, four 50-inch flat displays are arranged so that the four screens form one larger screen as a whole.

However, since such a flat display always had a frame, one image displayed on the four joined screens would have a cross of the frames at the center and was thus seen with difficulty. As such, a certain image was sometimes unsuitable for display on the framed screens.

As one of means for solving such a problem, a multi-screen display has been suggested which allows a plurality of projectors to project an image onto a 100-inch or more size screen, thereby forming a larger screen (for example, see Japanese Patent Laid-Open Publication No. 2002-107831).

However, with such a well-known conventional multi-screen display, those images projected from the plurality of projectors onto the screen overlapped one another, thereby readily causing the overlapped portions to appear as thin stripe-shaped boundary lines. It was thus necessary to provide a special treatment for the overlapped portions such as shading.

### DISCLOSURE OF THE INVENTION

The present invention was developed in view of these problems. It is therefore an object of the present invention to provide a rear projection multi-screen display device which prevents boundary lines from appearing on a larger screen when images are projected from a plurality of projectors onto screens to thereby form the large screen. It is also an object of the invention to provide a collective screen, an optical fiber and a flat optical fiber for a collective screen to be used therefor.

The present invention solves the aforementioned problems by using a collective screen that includes a plurality of unit screens having at least two types of lengths in the direction of thickness of the screen, with their front end surfaces or optical image output faces joined together flush with each other without any clearance therebetween, wherein the collective screen is thus provided with a single continuous collective optical image output face. The collective screen has the unit screens of different lengths disposed to be adjacent to each other. On the other hand, each of the unit screens is provided with a plurality of optical fibers. The optical fibers have the same length within the range of 5 mm to 100 cm and are integrally joined together so that at least their front ends and rear ends are aligned substantially in radial contact with each other. Furthermore, the optical image output face of each of the unit screens forms part of the collective optical image output face, and the rear end surface thereof constitutes an optical image input face.

Here, the optical image output faces of adjacent unit screens are flush with each other to form a collective optical image output face having no boundary line, whereas the adjacent optical image input faces are not aligned with each other in the direction of the optical axis of the optical fibers. Accordingly, there will be no boundary lines resulted from overlapped portions of those images projected onto these adjacent optical image input faces from the different projectors.

### BRIEF DESCRIPTION OF THE DRAWINGS

FIG. 1 is a perspective front view of a rear projection multi-screen display device according to Embodiment 1 of the present invention;

FIG. 2 is a perspective rear view of the rear projection multi-screen display device;

FIG. 3 is a perspective rear view illustrating only the unit screens in Embodiment 1;

FIG. 4 is a cross-sectional view taken along the line IV-IV of FIG. 1;

FIG. 5 is an enlarged cross-sectional view illustrating Portion V of FIG. 4;

FIG. 6 is an enlarged perspective view illustrating Portion VI of FIG. 3;

FIG. 7 is an enlarged sectional view taken along the line VII-VII of FIG. 6;

FIG. 8 is a block diagram illustrating an image signal processing system of the rear projection multi-screen display device according to Embodiment 1;

FIG. 9 is a schematic perspective view illustrating a rear projection multi-screen display device according to Embodiment 2;

FIG. 10 is a schematic perspective view illustrating a rear projection multi-screen display device according to Embodiment 3;

FIG. 11 is a schematic front view illustrating a unit screen according to Embodiment 4;

FIG. 12 is a schematic front view illustrating a unit screen according to Embodiment 5;

FIG. 13 is a schematic front view illustrating a unit screen according to Embodiment 6;

FIG. 14 is a schematic front view illustrating a unit screen according to Embodiment 7;

FIG. 15 is a schematic front view illustrating a unit screen according to Embodiment 8;

FIG. 16 is a schematic perspective view illustrating a flat optical fiber in Embodiment 9;

FIG. 17 is a schematic cross-sectional view illustrating the main portion of a unit screen according to Embodiment 10;

FIG. 18 is a schematic cross-sectional view illustrating the main portion of a unit screen according to Embodiment 11;

FIG. 19 is a schematic cross-sectional view illustrating the main portion of a unit screen according to Embodiment 12;

FIG. 20 is a schematic perspective view illustrating a rear projection multi-screen display device according to Embodiment 13.

### BEST MODE FOR CARRYING OUT THE INVENTION

A rear projection multi-screen display device is configured to include a projection section configured to have a total of twelve projectors arranged in 3 rows by 4 columns and a collective screen having a collective optical image output face through which an optical image projected from the projection section is transmitted. The collective screen is configured to include a total of twelve unit screens which are each provided at a position of an optical image projected by each of the 12 projectors: 6 short unit screens and 6 long unit screens having a longer size in a thickness direction of the screens than that of the short unit screens. These unit screens are disposed in a staggered arrangement when viewed from the front of the screens. The short unit screens and the long unit screens are provided with a plurality of optical fibers which have the same length in the range of 5 mm to 100 cm and are integrally joined together so that their front ends and rear ends are aligned in radial contact with each other. By this configuration, the aforementioned objects are achieved.

### EMBODIMENT 1

Now, the present invention will be described in accordance with Embodiment 1 with reference to the drawings.

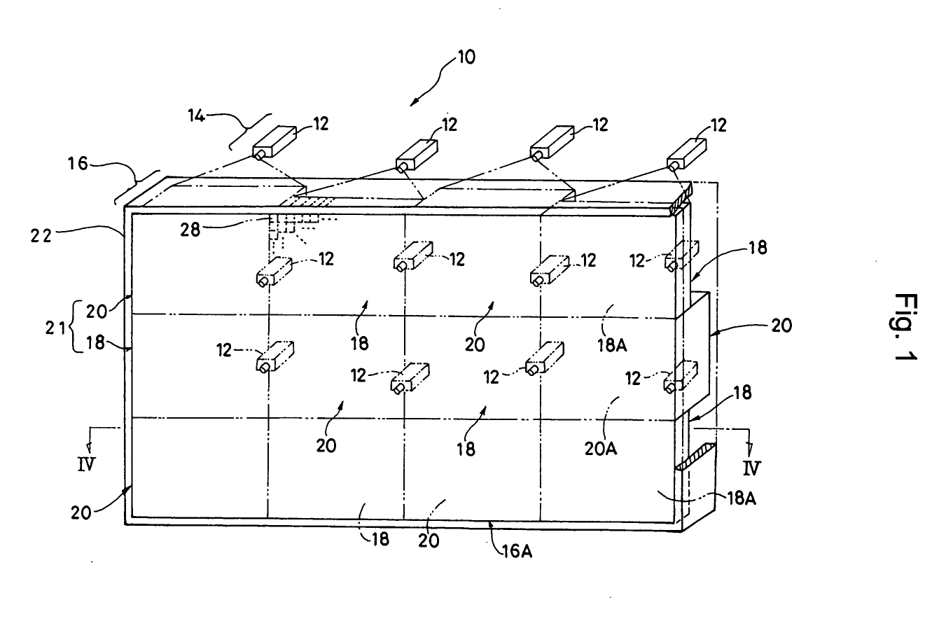

As shown in FIG. 1, a rear projection multi-screen display device 10 according to this example of one embodiment is configured to include: a projection section 14 having, for example, a total of twelve DLP (Digital Light Processing: trademark) type projectors 12 which are arranged in 3 rows by 4 columns and each emit a normal size optical image with a vertical to horizontal ratio of 3:4; and a collective screen 16 having a collective optical image output face 16A through which an optical image projected from the projection section 14 is transmitted.

The collective screen 16 is configured to include a total of twelve unit screens 21 (the unit screens 21 generally refer to short unit screens 18 and long unit screens 20) which are each provided at a position of an optical image projected by each of the twelve projectors 12, wherein the unit screens 21 include six short unit screens 18, and six long unit screens 20 which have a longer size in the thickness direction of the screens than that of the short unit screen 18. These short unit screens 18 and long unit screens 20 are disposed in a staggered arrangement when viewed from the front of the screens. Furthermore, these twelve unit screens 21 are joined together such that their respective front end surfaces or optical image output faces 18A and 20A are aligned flush with each other without any clearance therebetween. The plurality of optical image output faces 18A and 20A constitute the single continuous collective optical image output face 16A which has a high-definition size with a vertical to horizontal ratio of 9:16.

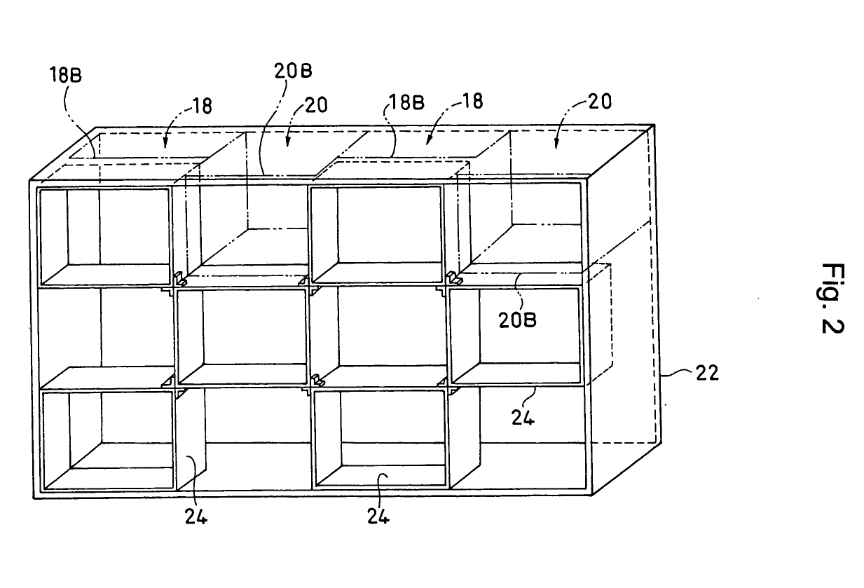

Furthermore, the collective screen 16 includes a collective screen support framework 22 for securely restraining the front-end outer circumference of all the unit screens 21 which are integrated with each other to form the collective optical image output face 16A. As shown in FIG. 2 (a rear perspective view), inside the collective screen support framework 22, support frames 24 for supportively restraining the outer circumference of the long unit screens 20 near their optical image input faces 20B are integrally disposed in a staggered arrangement.

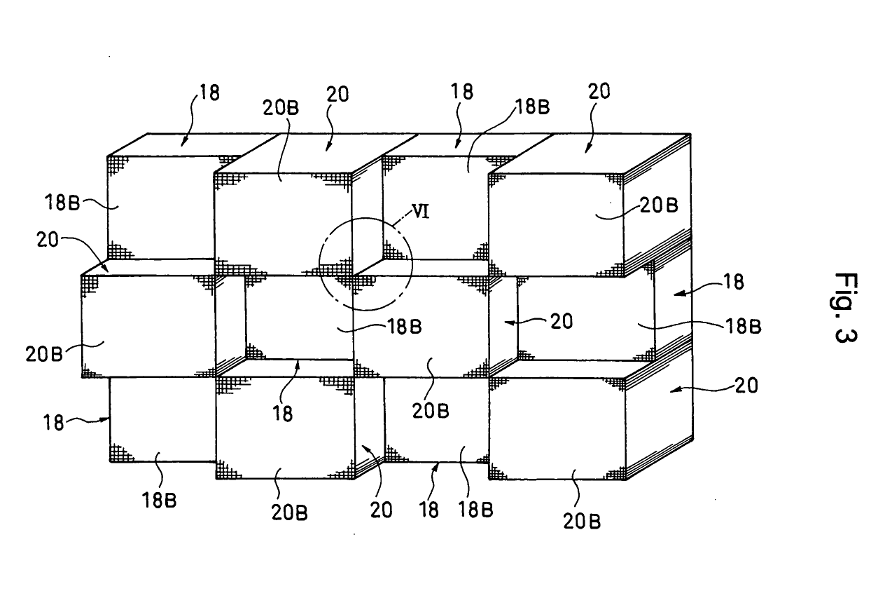

Now, refer to FIG. 3 (a rear perspective view) and FIG. 4 (a cross-sectional view) in which the collective screen support framework 22 and the support frames 24 are not illustrated. As shown in the figures, the collective screen 16 supported by the collective screen support framework 22 and the support frames 24 has the short unit screens 18 and the long unit screens 20 disposed in a staggered arrangement. Note that the outer circumferential portion of each of the unit screens 21 being in contact with the collective screen support framework 22 or the support frames 24 is securely adhered thereto with an adhesive via an isolating sheet 25.

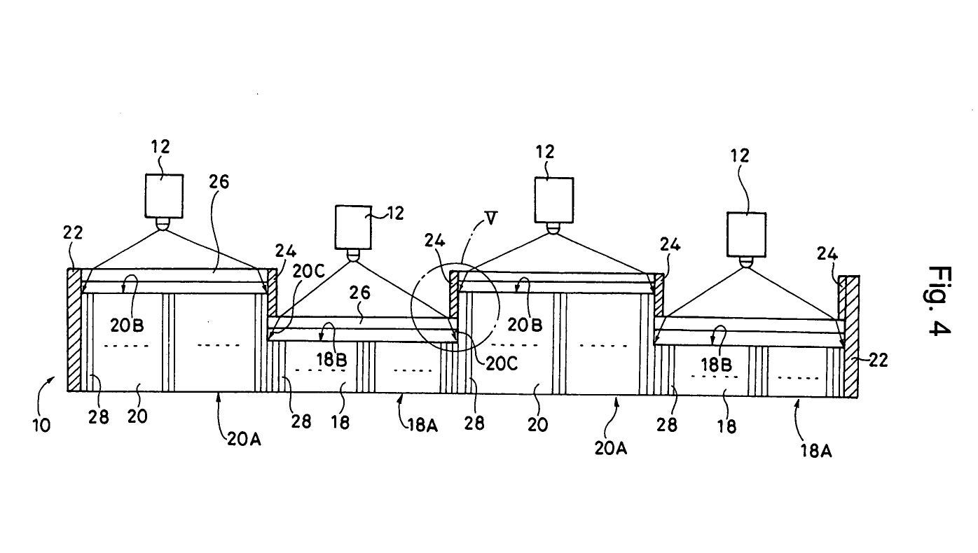

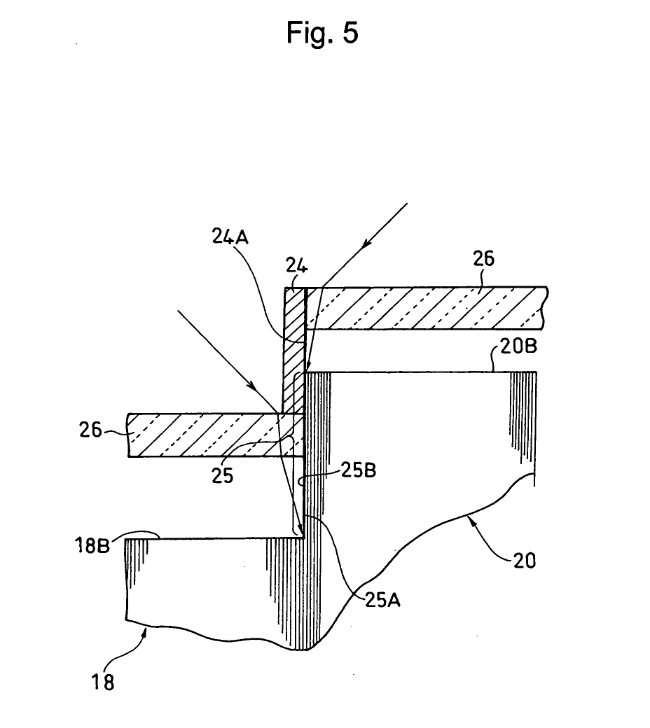

As shown in FIG. 5, the support frame 24 has a protruded portion 24A which protrudes toward the projector 12 with respect to the optical image input face 20B of the long unit screen 20. The protruded portion 24A surrounds the optical image input face 20B onto which an optical image is projected, thereby shielding any leakage light of the optical image out of the optical image input face 20B. The protruded portion 24A is coated with a light absorbing layer 24B such as non-reflective coating.

Furthermore, as shown in FIG. 5, the outer circumference of a portion of the long unit screen 20 protruded backwardly (toward the projector) relative to the short unit screen 18 is surrounded by the isolating sheet 25 and restrained by the support frame 24 via the isolating sheet 25. The isolating sheet 25 has an inner surface which serves as a reflecting layer 25A as well as a light absorbing layer 25B such as non-reflective coating, thereby preventing occurrence of reflected light.

Note that the light absorbing layer 25B covers a range around the optical image input face 18B of an adjacent short unit screen 18 at least in a length of 5 mm from the optical image input face 18B. The light absorbing layer 25B is configured to shield leakage light of an optical image out of the optical image input face 18B, the optical image being projected from the projector 12 onto the optical image input face 18B of the short unit screen 18.

As shown in FIG. 4, the short unit screen 18 and the long unit screen 20 are provided with a plurality of optical fibers 28 which have the same length within the range of 5 mm to 100 cm and are integrally joined together so that their front ends and rear ends are aligned radially adjacent to each other. Furthermore, the optical fibers 28 constituting the long unit screen 20 are longer by 1 cm or more than the optical fibers 28 that constitute the short unit screen 18.

Note that the optical fiber 28 has a length of 5 mm to 100 cm because a length less than 5 mm does not allow sufficiently concentrated light to pass through the core of the optical fiber. On the other hand, the length of 100 cm is employed because a length greater than 100 cm causes an excessive increase in the weight of the entire screen, and an optical fiber of resin causes an increased loss of light.

Furthermore, the end surfaces of these short unit screens 18 and long unit screens 20 facing the projectors 12 are defined as the optical image input end faces 18B and 20B, while the other end surfaces are defined as the optical image output end faces 18A and 20A. An optical image supplied through the optical image input end faces 18B and 20B is output as it is through the opposite end surfaces or the optical image output end faces 18A and 20A. Note that Fresnel lenses 26 are disposed on the optical paths between the unit screens 21 and the corresponding projectors 12, respectively.

In Embodiment 1, the Fresnel lens 26 is attached to the support frame 24 at a position spaced apart from the optical image input end faces 18B and 20B. Furthermore, as shown in FIG. 5, the distance between the Fresnel lens 26 and the projector 12 is set to be slightly less than the focal length of the Fresnel lens 26. This allows an optical image refracted through the Fresnel lens 26 to be slightly diverged from the collimated beam of light and then incident upon the optical image input end faces 18B and 20B.

As illustrated with an enlarged portion in FIG. 6, the unit screen 21 has multiple corrugated plates 23 which are stacked one on another in the vertical direction in the figure. FIG. 6 is a perspective view, from the projector side, illustrating a portion where the short unit screens 18 and the long unit screens 20 are adjacent to each other in a staggered arrangement.

The aforementioned corrugated plate 23 is a metal channel member which is provided by corrugating a thin metal plate in the shape of rectangular waveforms so that generally square cross sections are repeated successively.

For example, the thin metal plate is formed of a thin aluminum plate whose surface reflectivity is increased such as by polishing or nickel plating. Many of the corrugated plates 23 are stacked in layers so that their generally square hollow portions are arranged side by side with the equal pitch in the vertical and horizontal directions. The hollow portion serves as a hollow core 28A generally square in cross section, and the thin metal plate serves as a circumferential wall portion 28B for forming a reflective face to surround the hollow core 28A. The hollow core 28A and circumferential wall portions 28B constitute each of the optical fibers 28.

On the outermost circumference of the collective screen 16, a half number of the optical fibers 28 have outwardly opened hollow cores 28A. In this case, the outermost circumference may be covered with an isolating sheet 25 which is equivalent to the one described above, or alternatively, the collective screen support framework 22 may be provided with a reflective inner surface.

Furthermore, in Embodiment 1, each of the corrugated plates 23 is formed to have the same width as the entire width of the collective screen 16, and a shorter portion corresponding to the short unit screen 18 and a longer portion corresponding to the long unit screen 20 in the direction of depth (the thickness direction of the screen). The corrugated plates 23 are stacked in layers, so that the short unit screens 18 and the long unit screens 20 are disposed in a staggered arrangement.

However, each of the corrugated plates 23 is continuous without any boundaries across the entire width of the collective screen 16 in a range in which the width thereof is equal to the length of the short unit screen 18. On the other hand, there is a step height at a transitional portion from a portion corresponding to the short unit screen 18 to a portion corresponding to the long unit screen 20.

Note that the long unit screen 20 and the short unit screen 18 may be separately formed and then assembled into the collective screen 16. As described above, the isolating sheet 25 is provided on its inner surface with the reflective face layer 25A to enclose the opening of the hollow core 28A, thereby forming part of the optical fiber 28.

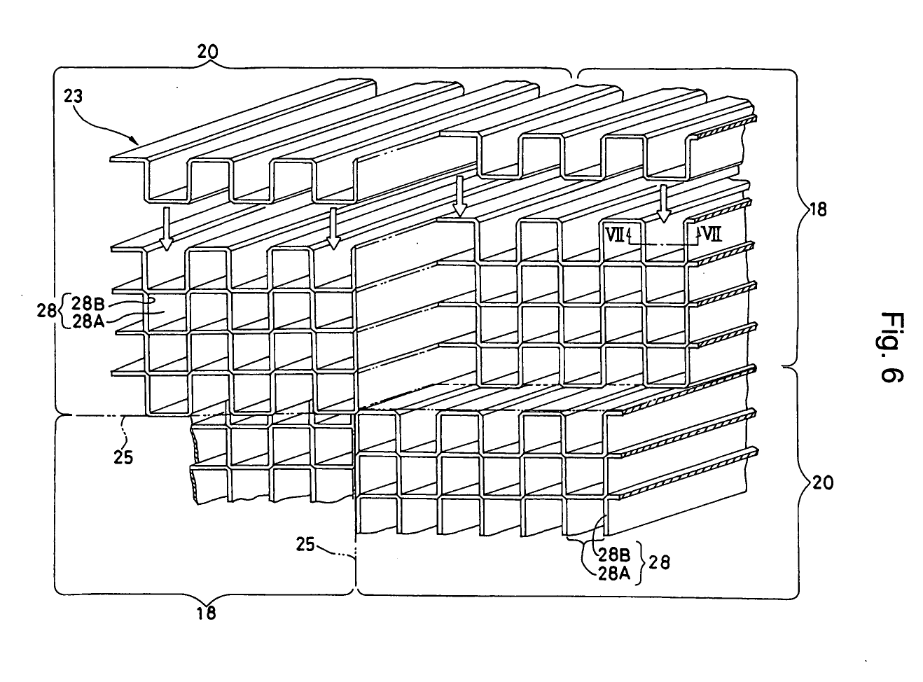

Furthermore, as shown in FIG. 7, the circumferential wall portion 28B of the optical fiber 28 is tapered and thus reduced in material thickness toward the end face 18B (20B) near the optical image input end face 18B (20B). In addition to this, the circumferential wall portion 28B forms an edge 29 on which the end face 18B (20B) has a material thickness D1 of 0.05 mm or less (in FIG. 6, the edge 29 is not shown). As a result, an optical image projected from the projectors 12 can be efficiently guided to the optical image output end face 18A (20A) with a less amount of light being reflected or absorbed on the optical image input end face 18B (20B) of the unit screens 21. Furthermore, both the end faces of the optical fiber 28 are coated with a black coating layer 28B. This makes it possible to prevent degradation in image quality due to reflected light on the optical image input end face 18B (20B), while providing a black stripe to sharpen the emitted beam of light on the optical image output end face 18A (20A).

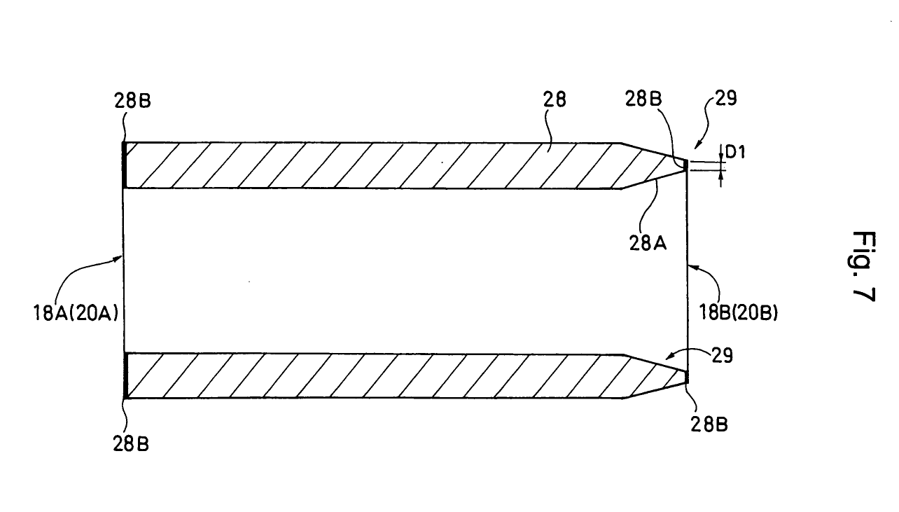

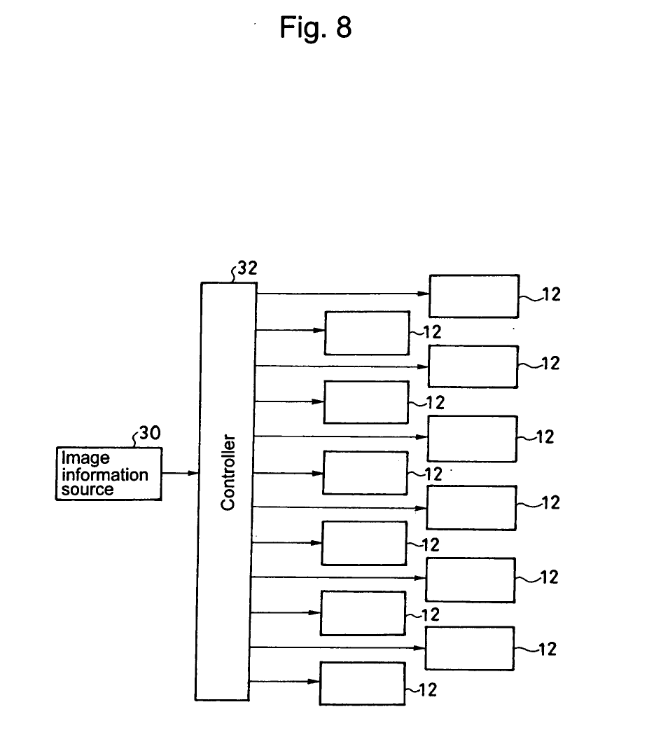

FIG. 8 shows an image signal processing circuit of the rear projection multi-screen display device 10.

The processing circuit includes a controller 32 with a dividing board which may or may not divide image information from an image information source 30, such as a DVD (Digital Versatile Disc), CD (Compact Disc), TV signal receiver, videotape recorder, or hard disk, for delivery to the twelve projectors 12.

The dividing board of the controller 32 sends the image signal from the image information source 30 to the right or left nine projectors 12 of the rear projection multi-screen display device 10 in the case of the normal screen of a vertical to horizontal ratio of 3:4. In the case of the high-definition screen of a vertical to horizontal ratio of 9:16, the image signal is sent to all the twelve projectors 12. In either case, the image is thus displayed in the normal size or the high-definition size on the collective optical image output face 16A, or if necessary, each of the projectors 12 is switched to display the same image. Then, the projectors 12 project a beam of light quadrangular in cross section while the pixels formed by each of the optical fibers 28 are sequentially scanned on the optical image input faces 18B and 20B of the unit screens 21 or all the pixels are switched every one image frame.

According to the rear projection multi-screen display device 10 of this embodiment of the present invention, the collective screen 16 includes the short unit screens 18 and the long unit screens 20, which are different in length. The optical image output faces 18A and 20A of the short unit screens 18 and the long unit screens 20 are disposed adjacent to each other across the collective optical image output face 16A. In addition to this, even at the interface between the adjacent optical image output end faces 18A and 20A of each of the unit screens 21, the optical fibers 28 are disposed successively side by side with the same pitch in the vertical and horizontal directions without any clearance therebetween. Accordingly, no boundary lines appear on the screen even when an image is projected onto the collective screen 16 from the multiple projectors 12 to thereby form the large screen. It is also possible to ensure that the collective screen 16 is supported with the support frames 24 using the difference in length between the long and short unit screens.

### EMBODIMENT 2

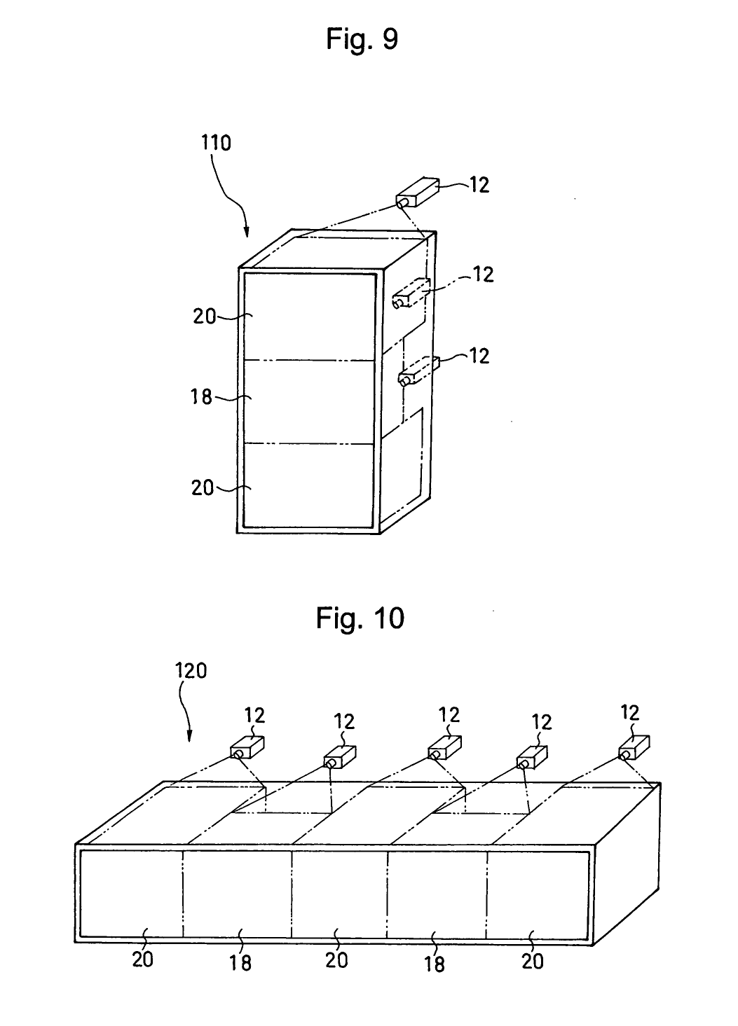

The rear projection multi-screen display device 10 according to the aforementioned embodiment includes the twelve short and long unit screens 18 and 20 and projectors 12; however, the present invention is not limited thereto. The invention can also be applied to a case where a plurality of unit screens having two types of lengths and a plurality of projectors provided corresponding thereto are available. Thus, for example, the invention can also be applied to a rear projection multi-screen display device 110 of Embodiment 2 shown in FIG. 9, in which the short and long unit screens 18 and 20 and the projectors 12 are arranged only in the vertical direction.

### EMBODIMENT 3

Furthermore, like a rear projection multi-screen display device 120 of Embodiment 3 shown in FIG. 10, the short and long unit screens 18 and 20 and the projectors 12 may also be arranged only in the horizontal direction.

### EMBODIMENT 4

Furthermore, the cross-sectional shape and structure of an optical fiber constituting the unit screen are not limited to those of the optical fiber 28 according to each of the aforementioned embodiments. Accordingly, the optical fiber may have a solid core, or a hollow core shaped as in a pipe. Furthermore, for the hollow core, the optical fiber may be formed of a metal pipe with the inner circumferential surface of its hollow core serving as a reflective surface. Of course, the optical fiber may also be formed of resin or silica.

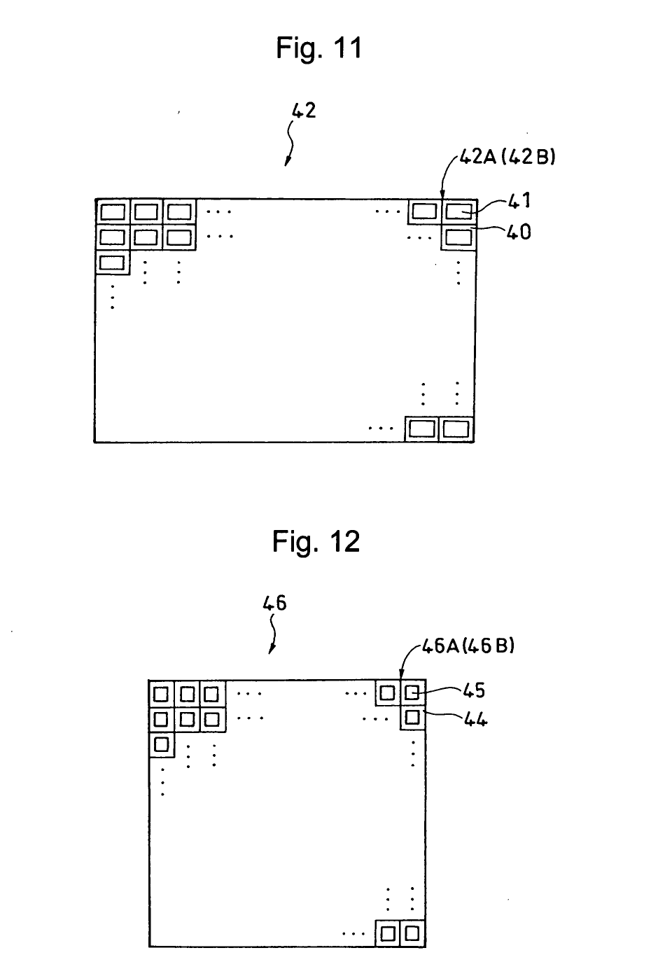

For example, as shown in FIG. 11, using a solid resin optical fiber 40 (symbol 41 indicating its core) with a quadrangular end face (rectangular), an optical image output face 42A (or an optical image input face 42B) of a unit screen 42 may be formed in the shape of a quadrangle by joining the quadrangular end faces together.

### EMBODIMENT 5

Furthermore, as shown in FIG. 12, it is also possible to employ a unit screen 46 which uses a solid resin optical fiber 44 with a square end face (symbol 45 indicating its core).

### EMBODIMENT 6

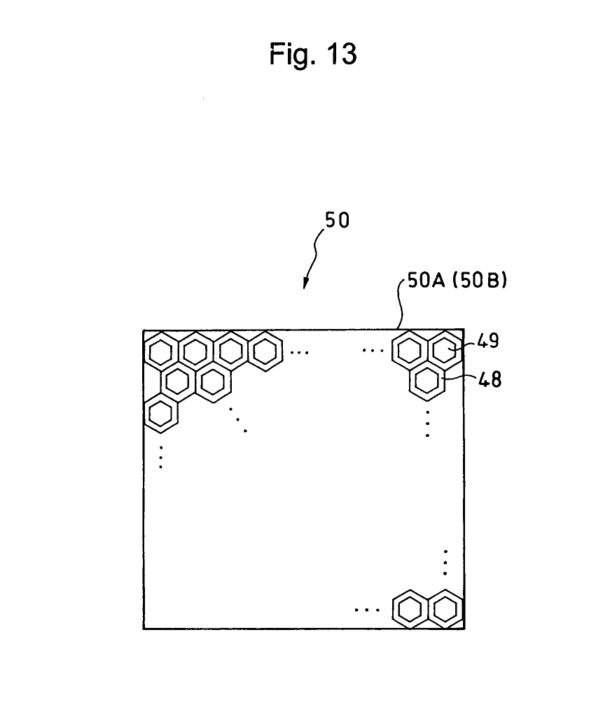

Furthermore, as shown in FIG. 13, a solid resin or hollow metal optical fiber 48 with a regular hexagonal end face (symbol 49 indicating its core or hollow core) may be used. An optical image output face 50A (or an optical image input face 50B) of a unit screen 50 may be thus shaped such that these regular hexagonal shapes are closely joined together in the most densely filled arrangement.

### EMBODIMENT 7

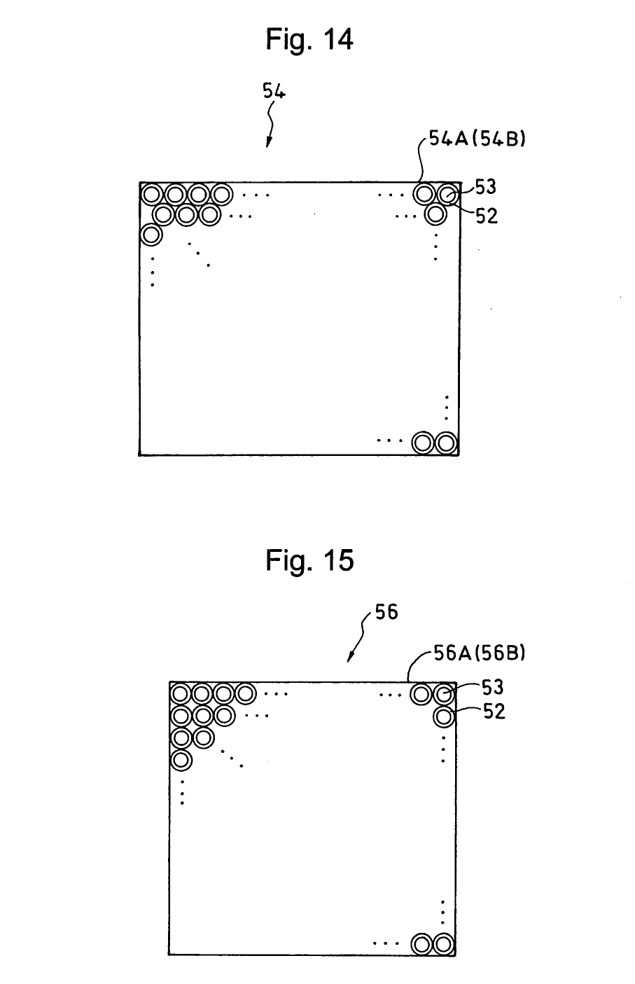

Furthermore, as shown in FIG. 14(A), a solid or hollow optical fiber 52 with a circular end face (symbol 53 indicating its core or hollow core) may be used. An optical image output face 54A (or an optical image input face 54B) of a unit screen 54 may be thus formed such that these circular shapes are closely joined together in the most densely filled arrangement.

### EMBODIMENT 8

Furthermore, like a unit screen 56 shown in FIG. 15, optical fibers 52 may be joined together with their circular end faces being disposed with the same pitch in the vertical and horizontal directions of the screen.

### EMBODIMENT 9

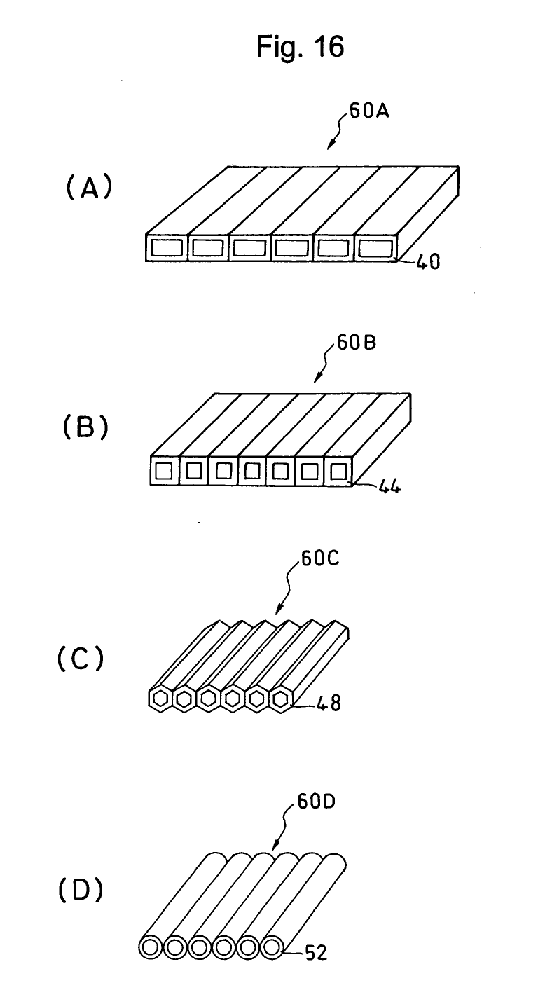

Furthermore, the unit screen 21 may be provided with flat optical fibers 60A to 60D as shown in FIGS. 16(A) to (D), thereby facilitating its manufacturing. To obtain the flat optical fiber 60A of FIG. 16(A), a plurality of the optical fibers 40 having a quadrangular end face are arranged side by side and integrally formed in the shape of a belt. In addition, as mentioned above, the flat optical fiber 60B with the optical fibers 44 of a square end face being formed in the shape of a belt (FIG. 16(B)) may be employed. It is also possible to employ the flat optical fiber 60C with the optical fibers 48 of a regular hexagonal end face being formed in the shape of a belt (FIG. 16(C)) or the flat optical fiber 60D with the optical fibers 52 of a circular end face being formed in the shape of a belt (FIG. 16(D)).

### EMBODIMENT 10

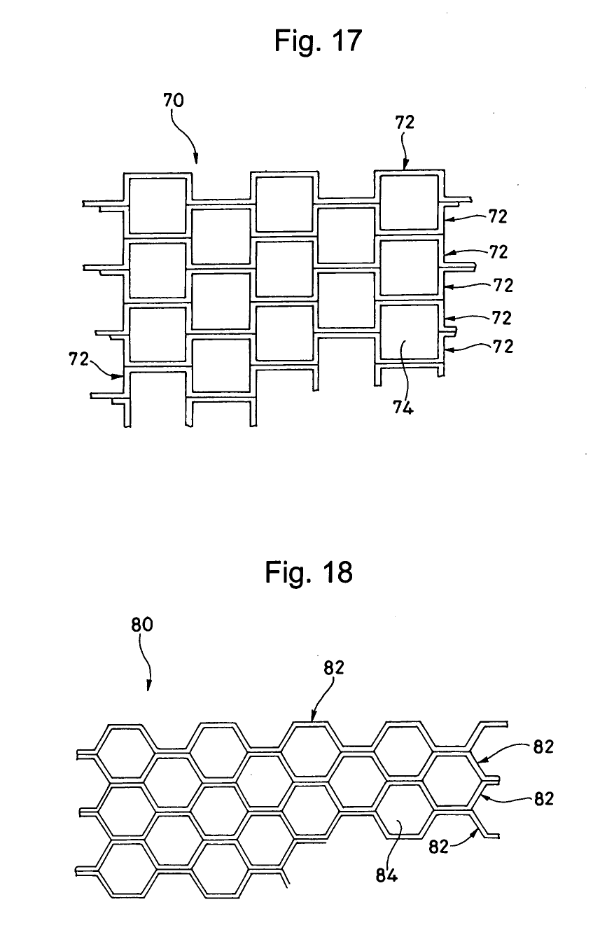

With reference to FIGS. 17 to 19, a description will be made to another embodiment for forming a unit screen with channel members (corrugated plates) as in Embodiment 1.

As shown in FIG. 17, a unit screen 70 according to Embodiment 10 is configured such that a thin metal plate is corrugated into a channel member (corrugated plate) 72 with successive quadrangular cross sections. Then, the channel members 72 are stacked in layers so that two of the quadrangular cross sections are disposed opposite to each other to form a hollow core 74 with a doubled quadrangular cross-sectional area.

The unit screen 70 of Embodiment 10 is provided with an increased joint area when compared with the unit screen 21, and thus increased in rigidity.

### EMBODIMENT 11

As shown in FIG. 18, a unit screen 80 according to Embodiment 11 is configured such that a thin metal plate is corrugated into a channel member (corrugated plate) 82 with successive trapezoidal cross sections. Then, the channel members 82 are stacked in layers so that two of the trapezoidal cross sections are disposed opposite to each other to form a hexagonal hollow core 84.

### EMBODIMENT 12

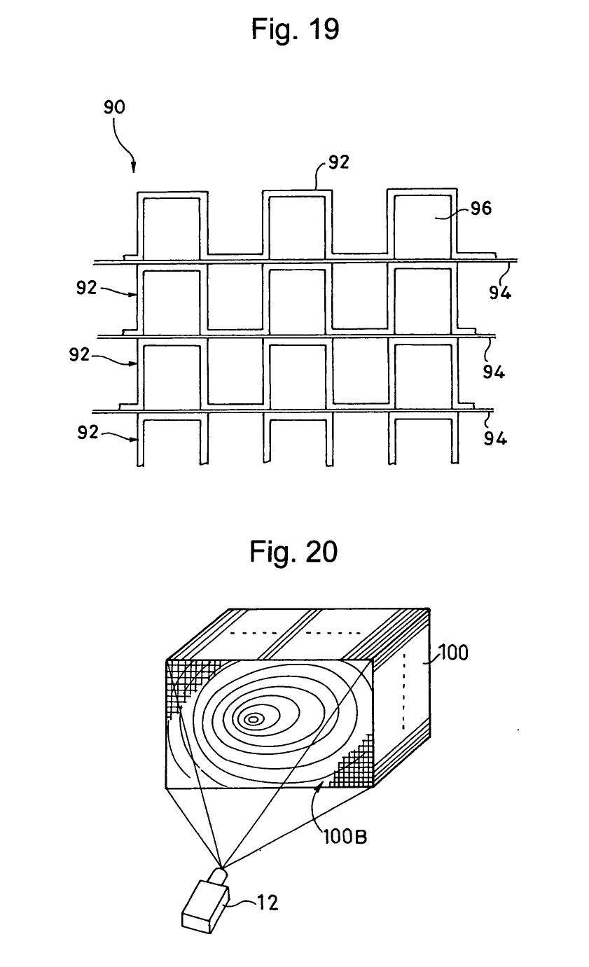

As shown in FIG. 19, a unit screen 90 according to Embodiment 12 is configured such that a thin metal plate is corrugated into a channel member (corrugated plate) 92 with successive quadrangular cross sections. Then, a right flat reinforcing thin metal plate 94 is coupled to the channel member 92 to close the quadrangular cross sections and thereby form hollow cores 96 with closed quadrangular cross sections disposed successively side by side. The channel members 92 and the reinforcing thin metal plates 94 are stacked in layers in the thickness direction to form the unit screens 90.

Note that in the embodiments described above, the projector 12 employs a DLP scheme; however, other projectors such as those that employ translucent liquid crystal panels may also be used. Furthermore, as required, the collective optical image output face 16A may also be provided with a light diffusing sheet.

### EMBODIMENT 13

Furthermore, the Fresnel lens 26 is placed on an optical path between the unit screen 21 and the projector 12 associated therewith in order to reduce the angle of incidence of an optical image from the projector 12. However, when an optical image is projected at a small angle, the Fresnel lens 26 can be eliminated. Furthermore, as shown in FIG. 19, it is also possible to employ a unit screen 100 which has an optical image input face 100B with a concave spherical surface. In this case, the Fresnel lens can be eliminated or used concurrently.

### INDUSTRIAL APPLICABILITY

The rear projection multi-screen display device of the present invention and the collective screen, an optical fiber and a flat optical fiber for a collective screen used therefor provide an effect that no boundary lines appear on a larger screen when images are projected from multiple projectors onto screens to thereby form the large screen. It is thus possible to employ them in the film and advertisement industries.

1. A collective screen for a rear projection multi-screen display device comprising a plurality of unit screens having at least two types of lengths in a direction of thickness of the screen, with front end surfaces or optical image output faces thereof joined together flush with each other without any clearance therebetween, wherein the collective screen is provided with a single continuous collective optical image output face, the unit screens of different lengths are disposed to be adjacent to each other, each of the unit screens is provided with a plurality of optical fibers which have the same length within the range of 5 mm to 100 cm and are integrally joined together so that at least front ends and rear ends thereof are aligned substantially in radial contact with each other, and a rear end surface of each of the unit screens constitutes an optical image input face.

2. The collective screen for a rear projection multi-screen display device according to claim 1, wherein: the plurality of unit screens include two types of a short unit screen and a long unit screen which is longer by at least 1 cm or more than the short unit screen in the direction of thickness of the screen, and the optical image output faces of the short unit screens and the optical image output faces of the long unit screens are disposed in a staggered arrangement on the collective optical image output face.

3. The collective screen for a rear projection multi-screen display device according to claim 1, wherein the optical image input face of the long unit screen is surrounded by a mask member for shielding any leakage light of an optical image out of the optical image input face of the long unit screen, the optical image being projected onto the optical image input face.

4. The collective screen for a rear projection multi-screen display device according to claim 1, wherein an antireflective coating is applied to an outer circumferential surface of the long unit screen adjacent to the optical image input face of the short unit screen in a range of at least 5 mm from the optical image input face of the short unit screen towards the rear end thereof.

5. The collective screen for a rear projection multi-screen display device according to claim 1, comprising a support frame for restraining at least an outer circumference of the long unit screen near the optical image input face to support the long unit screen.

6. The collective screen for a rear projection multi-screen display device according to claim 5, wherein the support frame is configured to shield any leakage light of an optical image out of the optical image input face of the long unit screen, the optical image being projected onto the optical image input face.

7. The collective display screen according to claim 1, comprising a collective screen support framework for surrounding the single continuous collective optical image output face and securely restraining a front-end outer circumference of the unit screens bundled to constitute the collective optical image output face.

8. The collective screen for a rear projection multi-screen display device according to claim 6, comprising a collective screen support framework for surrounding the single continuous collective optical image output face and securely restraining a front-end outer circumference of the unit screens bundled to constitute the collective optical image output face, and the collective screen support framework is provided integrally with the support frame.

9. The collective screen for a rear projection multi-screen display device according to claim 1, wherein the optical fiber has a quadrangular rear end surface, and the optical image input face of the unit screen is formed in a quadrangular shape with the quadrangular rear end surfaces joined together.

10. The collective screen for a rear projection multi-screen display device according to claim 1, wherein the optical fibers have a regular hexagonal rear end surface and are closely joined together for these regular hexagonal shapes to be formed in a most densely filled arrangement, thereby forming the optical image input face.

11. The collective screen for a rear projection multi-screen display device according to claim 1, wherein the optical fibers have a circular rear end surface and are closely joined together for these circular shapes to be formed in a most densely filled arrangement, thereby forming the optical image input face.

12. The collective screen for a rear projection multi-screen display device according to claim 1, wherein the optical fibers have a quadrangular front end surface, and these quadrangular front end surfaces are joined together so as to be disposed with the same pitch in vertical and horizontal directions of the screen, thereby forming the optical image output face.

13. The collective screen for a rear projection multi-screen display device according to claim 1, wherein the optical fibers have a regular hexagonal front end surface, and these regular hexagonal front end surfaces are joined together for these regular hexagonal shapes to be formed in a most densely filled arrangement, thereby forming the optical image output face.

14. The collective screen for a rear projection multi-screen display device according to claim 1, wherein the optical fibers have a circular front end surface, and these circular front end surfaces are closely joined together for these circular shapes to be formed in a most densely filled arrangement, thereby forming the optical image output face.

15. The collective screen for a rear projection multi-screen display device according to claim 1, wherein the optical fibers have a circular front end surface, and these circular shapes are joined together so as to be disposed with the same pitch as a diameter of the circular shape in vertical and horizontal directions of the screen, thereby forming the optical image output face.

16. The collective screen for a rear projection multi-screen display device according to claim 1, for use in a rear projection multi-screen wherein the optical fiber has a shape of a hollow core pipe.

17. The collective screen for a rear projection multi-screen display device according to claim 16, wherein the front end surface of the optical fiber is coated with a black coating layer.

18. The collective screen for a rear projection multi-screen display device according to claim 16, wherein the rear end surface of the optical fiber is coated with a black coating layer.

19. The collective screen for a rear projection multi-screen display device according to claim 1, wherein the optical fibers constituting the unit screen are formed of either resin or silica.

20. The collective screen for a rear projection multi-screen display device according to claim 16, wherein the optical fibers constituting the unit screen are formed of a metal channel member with an inner circumferential surface of a hollow core serving as a reflective face.

21. The collective screen for a rear projection multi-screen display device according to claim 20, wherein the metal channel member is formed of a thin metal plate which is bent into a generally rectangular waveform so as to have inner hollow cores and allow the cores to be disposed successively.

22. The collective screen for a rear projection multi-screen display device according to claim 21, wherein the thin metal plate is corrugated, and a plurality of the thin metal plates are joined together one on another in a direction of thickness so as to close the hollow cores, to constitute the unit screens.

23. The collective screen for a rear projection multi-screen display device according to claim 22, wherein the thin metal plate is formed to provide successive quadrangular cross sections, and two of the quadrangular cross sections are opposed to each other to form a quadrangle of a doubled cross-sectional area as a core.

24. The collective screen for a rear projection multi-screen display device according to claim 23, wherein the thin metal plate is formed to have successive trapezoidal cross sections, and two of the trapezoidal cross sections are opposed to each other to form a hexagonal core.

25. The collective screen for a rear projection multi-screen display device according to claim 21, wherein: the thin metal plate is corrugated; the thin metal plate is connected with a thin right flat reinforcing metal plate to close the quadrangular cross sections and thus form closed quadrangular cross sections disposed successively side by side; and the corrugated thin metal plate and the reinforcing thin metal plate are joined together one on the other in a direction of thickness, thereby forming the unit screens.

26. The collective screen for a rear projection multi-screen display device according to claim 21, wherein the inner circumferential surface of the hollow core of the optical fiber is tapered near an end face of the optical fiber to be increased in inner diameter toward the end face and to form an edge on which the metal channel member has a material thickness of 0.05 mm or less on the end face.

27. The collective screen for a rear projection multi-screen display device according to claim 1, wherein an outer circumferential surface of an end portion of the optical fiber is coated with a black coating layer in a range of at least 3 mm from the end face of the optical fiber.

28. The collective screen for a rear projection multi-screen display device according to claim 27, for use in a rear projection multi-screen wherein the black coating layer which coats the outer circumferential surface of the end portion of the optical fiber is formed of an adhesive for securely adhering the end portion of the optical fiber in a direction of a diameter thereof.

29. The collective screen for a rear projection multi-screen display device according to claim 1, wherein the rear end surface or the optical image input face of the unit screen is concave spherical.

30. A rear projection multi-screen display device, comprising:
a collective screen for serving as a single continuous collective optical image output face, the collective screen having front end surfaces or optical image output faces of a plurality of unit screens being collectively joined together flush with each other without any clearance therebetween, the plurality of unit screens having at least two types of lengths in a direction of thickness of the screen; and
projectors which are the same in number as the unit screens and disposed behind the collective screen corresponding respectively to the unit screens, the projector projecting an optical image onto a rear end surface or an optical image input face of the corresponding unit screen, wherein
the collective screen has the unit screens of different lengths disposed adjacent to each other, and
each of the unit screens is provided with a plurality of optical fibers which have the same length in a range of 5 mm to 100 cm and are integrally joined together so that at least front ends and rear ends thereof are aligned substantially in radial contact with each other.

31. The rear projection multi-screen display device according to claim 30, wherein: the plurality of unit screens include two types of a short unit screen and a long unit screen which is longer by at least 1 cm or more than the short unit screen in the direction of thickness of the screen, and the optical image output faces of the short unit screens and the optical image output faces of the long unit screens are disposed in a staggered arrangement on the collective optical image output face.

32. The rear projection multi-screen display device according to claim 30, wherein the optical image input face of the long unit screen is surrounded by a mask member for shielding any leakage light of an optical image out of the optical image input face of the long unit screen, the optical image being projected onto the optical image input face.

33. The rear projection multi-screen display device according to claim 30, wherein an antireflective coating is applied to an outer circumferential surface of the long unit screen adjacent to the optical image input face of the short unit screen in a range of at least 5 mm from the optical image input face of the short unit screen towards the rear end thereof.

34. The rear projection multi-screen display device according to claim 30, comprising a support frame for restraining at least an outer circumference of the long unit screen near the optical image input face to support the long unit screen.

35. The rear projection multi-screen display device according to claim 34, wherein the support frame is configured to protrude toward the projector with respect to the optical image input face of the long unit screen and to shield any leakage light of a projected optical image out of the optical image input face.

36. The rear projection multi-screen display device according to claim 34, wherein a Fresnel lens is attached to each of the support frames associated with the respective unit screens between the projector and the optical image input face of the unit screen associated therewith, the Fresnel lens slightly diverging or generally collimating an optical image projected from the projector.

37. The rear projection multi-screen display device according to claim 30, wherein the optical image input face of the unit screen is concave spherical, and a center of optical image emission of the projector is disposed near a center of the concave spherical surface.

38. The rear projection multi-screen display device according to claim 30, wherein a Fresnel lens is provided to each of the unit screens between the projector and the optical image input face of the unit screen associated therewith, the Fresnel lens slightly diverging or collimating an optical image diverged when projected from the projector.

39. The rear projection multi-screen display device according to claim 30, comprising a collective screen support framework for surrounding and securing an outer circumference of the unit screens integrated into one piece to constitute the collective optical image output face.

40. The rear projection multi-screen display device according to claim 34, wherein a collective screen support framework for surrounding and securing a front-end outer circumference of the unit screens integrated into one piece to constitute the collective optical image output face is integrated with the support frames.

41. The rear projection multi-screen display device according to claim 30, wherein the optical fiber has a quadrangular rear end surface, and the optical image input face of the unit screen is formed in a quadrangular shape with the quadrangular rear end surfaces joined together.

42. The rear projection multi-screen display device according to claim 41, wherein the optical fiber has a regular quadrangular rear end surface.

43. The rear projection multi-screen display device according to claim 30, wherein the projector is designed to project a beam of light quadrangular in cross section while scanning across the optical image input face.

44. The rear projection multi-screen display device according to claim 30, wherein the optical fibers have a hexagonal rear end surface and are closely joined together for these hexagonal shapes to be formed in a most densely filled arrangement, thereby forming the optical image input face.

45. The rear projection multi-screen display device according to claim 30, wherein the optical fibers have a circular rear end surface and are closely joined together for these circular shapes to be formed in a most densely filled arrangement, thereby forming the optical image input face.

46. The rear projection multi-screen display device according to claim 40, wherein the optical fibers have a quadrangular front end surface, and these quadrangular front end surfaces are joined together so as to be disposed with the same pitch in vertical and horizontal directions of the screen, thereby forming the optical image output face.

47. The rear projection multi-screen display device according to claim 30, wherein the optical fibers have a regular hexagonal front end surface, and these regular hexagonal front end surfaces are joined together for these regular hexagonal shapes to be formed in a most densely filled arrangement, thereby forming the optical image output face.

48. The rear projection multi-screen display device according to claim 30, wherein the optical fibers have a circular front end surface, and these circular front end surfaces are closely joined together for these circular shapes to be formed in a most densely filled arrangement, thereby forming the optical image output face.

49. The rear projection multi-screen display device according to claim 30, wherein the optical fibers have a circular front end surface, and these circular shapes are joined together so as to be disposed with the same pitch in vertical and horizontal directions of the screen, thereby forming the optical image output face.

50. The rear projection multi-screen display device according to claim 30, for use in a rear projection multi-screen wherein the optical fiber has a shape of a hollow core pipe.

51. The rear projection multi-screen display device according to claim 50, wherein the front end surface of the optical fiber is coated with a black coating layer.

52. The rear projection multi-screen display device according to claim 50, wherein the rear end surface of the optical fiber is coated with a black coating layer.

53. The rear projection multi-screen display device according to claim 30, wherein the optical fibers constituting the unit screen are formed of either resin or silica.

54. The rear projection multi-screen display device according to claim 50, wherein the optical fibers constituting the unit screen are formed of a metal channel member with an inner circumferential surface of a hollow core serving as a reflective face.

55. The rear projection multi-screen display device according to claim 54, wherein the metal channel is formed of a thin metal plate which is bent into a rectangular waveform so that quadrangular cross sections with an inner hollow core are successively formed.

56. The rear projection multi-screen display device according to claim 54, wherein the thin metal plate is corrugated, and a plurality of the thin metal plates are joined together one on another in a direction of thickness so as to close the hollow cores, to constitute the unit screens.

57. The rear projection multi-screen display device according to claim 55, wherein the thin metal plate is formed to provide successive quadrangular cross sections, and two of the quadrangular cross sections are opposed to each other to form a quadrangle of a doubled cross-sectional area as a core.

58. The rear projection multi-screen display device according to claim 57, wherein the thin metal plate is formed to have successive trapezoidal cross sections, and two of the trapezoidal cross sections are opposed to each other to form a hexagonal core.

59. The rear projection multi-screen display device according to claim 54, wherein: the thin metal plate is corrugated; the thin metal plate is connected with a thin right flat reinforcing metal plate to close the quadrangular cross sections and thus form closed quadrangular cross sections disposed successively side by side; and the corrugated thin metal plate and the reinforcing thin metal plate are joined together one on the other in a direction of thickness, thereby forming the unit screens.

60. The rear projection multi-screen display device according to claim 54, wherein the inner circumferential surface of the hollow core of the optical fiber is tapered near an end face of the optical fiber to be increased in inner diameter toward the end face and to form an edge on which the metal channel member has a material thickness of 0.05 mm or less on the end face.

61. The rear projection multi-screen display device according to claim 30, wherein an outer circumferential surface of an end portion of the optical fiber is coated with a black coating layer in a range of at least 3 mm from the end face of the optical fiber.

62. The rear projection multi-screen display device according to claim 61, wherein the black coating layer which coats the front-end outer circumferential surface of the optical fiber is formed of an adhesive for securely adhering the front end portion of the optical fiber in a direction of a diameter thereof.

63. The rear projection multi-screen display device according to claim 30, wherein the rear end surface or the optical image input face of the unit screen is concave spherical.

64. (canceled)

65. (canceled)

66. (canceled)

67. (canceled)

68. (canceled)

69. (canceled)

70. The rear projection multi-screen display device according to claim 30, wherein a plurality of the optical fibers for a collective screen are disposed side by side to be integrally formed in a shape of a belt.

71. The rear projection multi-screen display device according to claim 30, wherein the optical fiber comprising a thin metal plate which is bent into a quadrangular waveform so that quadrangular cross sections are successively formed, wherein a plurality of hollow optical fibers with each of the quadrangular cross sections having a hollow core are disposed side by side and integrally formed in a shape of a belt.

72. The rear projection multi-screen display device according to claim 71, wherein the thin metal plate is corrugated to be connectable one on another in a direction of thickness so as to close the hollow core.

73. (canceled)

74. (canceled)

75. (canceled)
